(19) United States
(12) Patent Application Publication
(10) Pub. No.: US 2006/0106604 A1
(43) Pub. Date: May 18, 2006

(54) Speech recognition dictionary creation device and speech recognition device

(76) Inventor: Yoshiyuki Okimoto, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 10/533,669

(22) PCT Filed: Nov. 7, 2003
(86) PCT No.: PCT/JP03/14168

§ 371 Date: May 3, 2005

(30) Foreign Application Priority Data
Nov. 11, 2002 (JP) 2002-326503

(51) Int. Cl. G10L 15/06

(52) U.S. Cl. 704/243

(57) ABSTRACT

A speech recognition dictionary creation device (10) that efficiently creates a speech recognition dictionary that enables even an abbreviated paraphrase of a word to be recognized with high recognition rate, the device including: a word division unit (2) that divides a recognition object made up of one or more words into constituent words; a mora string obtainment unit (3) that generates mora strings of the respective constituent words based on the readings of the respective divided constituent words; an abbreviated word generation rule storage unit (6) that stores a generation rule for generating an abbreviated word using moras; an abbreiivaed word generation unit (7) that generates candidate abbreviated words, each made up of one or more moras, by extracting moras from the mora strings of the respective constituent words and concatenating the extracted moras, and that generates an abbreviated word by applying the abbreviated word generation rule to such candidates; and a vocabulary storage unit (8) that stores, as the speech recognition dictionary, the generated abbreviated word together with its recognition object.

### TECHNICAL FIELD

The present invention relates to a speech recognition dictionary creation device for creating a dictionary used by a speech recognition device intended for an unspecified speaker and to a speech recognition device and the like for recognizing a speech using such dictionary.

### BACKGROUND ART

Conventionally, a speech recognition dictionary that defines recognition vocabulary is indispensable in a speech recognition device intended for unspecified speakers. A previously created speech recognition dictionary is used in the case where words to be recognized are definable at the time of system planning. However, in the case where vocabulary definition is not possible or where vocabulary needs to be changed dynamically, speech recognition vocabulary is generated by means of manual input or automatically from character string information, to be registered into the dictionary. For example, a speech recognition device in a television program switching device performs morphemic analysis on character string information that includes program information so as to determine its reading, and registers the obtained reading into the speech recognition dictionary. In the case of “NHK News 10”, for example, “enu eichi kei nyus ten (NHK News 10)” is registered into the speech recognition dictionary as a word representing the program. Accordingly, it becomes possible to achieve a function of switching the channel to “NHK News 10” in response to a user saying “enu eichi kei nyus ten (NHK News 10)”.

Meanwhile, in consideration that a user will not utter a word in a complete manner, there is a method for dividing a compound word into its constituent words and registering, into a dictionary, a paraphrase made up of partial character strings that results from concatenating constituent words (for example, technology disclosed in Japanese Laid-Open Patent application No. 2002-41081). According to the speech recognition dictionary creation device disclosed in this publication, words inputted as character string information are analyzed, pairs of speaking unit/reading are then prepared by taking into account all of their readings and all concatenated words, and such pairs are registered into a speech recognition dictionary. Accordingly, in the case of the above-described television program name “NHK News 10”, for example, the readings “enu eich kei nyus (NHK News)” and “nyus ten (News 10)” are registered into the dictionary, thereby allowing the user's utterance of them to be processed correctly.

Moreover, according to the above speech recognition dictionary creation method, a paraphrase is registered into the speech recognition dictionary after being assigned a weight in consideration of the following, for example: a likelihood that indicates the correctness of the reading given to the paraphrase; the order in which the words constituting the paraphrase appear; and the frequency at which such words are used in the paraphrase. Accordingly, it is expected that words that are more probable as the paraphrase can be selected by means of speech comparison.

As described above, the above conventional speech recognition dictionary creation method aims at supporting user's arbitrary utterances that are given in an abbreviated manner in addition to complete utterances of words by analyzing input character string information so as to reconstruct word strings that are made up of every combination of the analyzed words, and then by registering, into the speech recognition dictionary, the readings of the word strings as paraphrases of the input word.

However, the above conventional speech recognition dictionary creation method has problems such as described below.

Firstly, the number of character strings becomes enormous when character strings are generated by every combination of words in an exhaustive manner. Thus, when all of such character strings are registered into the speech recognition dictionary, the size of the dictionary becomes huge, which might lead to the decrease in recognition rate due to an increased amount of calculation and a large number of words that are similar in terms of phonemes. Furthermore, since it is highly possible that character strings and readings that are the same as those of the above paraphrases are generated from different words, it is extremely difficult to distinguish which word the user is intending to mean, even when a character string and reading are correctly recognized.

Furthermore, according to the above conventional speech recognition dictionary creation method, a weight of a paraphrase is determined by mainly using the likelihoods of words that appear in the paraphrase for the purpose of selecting the most likely candidate paraphrase from among a large number of candidate paraphrases registered. However, considering the case where “Kinyo dorama (Friday Drama)” is abbreviated and uttered as “kin dora”, for example, no consideration is taken concerning that a factor for determining likelihoods used for generating a paraphrase is more influenced by the number of phonemes extracted from words that have been used as constituents of a combination as well as being influenced by whether it is natural, as the Japanese language, to concatenate phonemes, rather than being influenced by words themselves that have been used as constituents of a combination. This causes a problem that an appropriate value cannot be given as a likelihood to each paraphrase.

Moreover, when a word is specified, there is usually one corresponding paraphrase. This is especially notable when a limited user is concerned. However, since the above speech recognition dictionary creation method does not exercise any controls concerning the generation of paraphrases by taking into account the use history of the paraphrases, there is a problem that the number of paraphrases to be generated and registered into the recognition dictionary cannot be appropriately controlled.

### DISCLOSURE OF INVENTION

In view of the above, it is an object of the present invention to provide a speech recognition dictionary creation device that efficiently creates a speech recognition dictionary that enables even an abbreviated paraphrase of a word to be recognized with high recognition rate and to provide a high performance speech recognition device that uses the speech recognition dictionary created by such speech recognition dictionary creation device and that requires a smaller number of resources.

In order to achieve the above object, the speech recognition dictionary creation device according to the present invention is a speech recognition dictionary creation device that creates a speech recognition dictionary, the device including: an abbreviated word generation unit that generates an abbreviated word of a recognition object that is made up of one or more constituent words based on a rule that takes into account ease of pronunciation; and a vocabulary storage unit that holds, as the speech recognition dictionary, the generated abbreviated word together with the recognition object. Accordingly, since an abbreviated word of the recognition object is generated based on a rule that takes into account the ease of pronunciation and such generated abbreviated word is registered as a speech recognition dictionary, it is possible to realize a speech recognition dictionary creation device that efficiently creates a speech recognition dictionary which allows even an abbreviated paraphrase of a word to be recognized with high recognition rate.

Here, the speech recognition dictionary creation device may further include: a word division unit that divides the recognition object into the constituent words; and a mora string generation unit that generates mora strings of the respective constituent words based on readings of the respective divided constituent words, wherein the abbreviated word generation unit may generate the abbreviated word made up of one or more moras by extracting one or more moras from the mora strings of the respective constituent words and concatenating the extracted moras based on the mora strings of the respective constituent words generated by the mora string generation unit. Here, the abbreviated word generation unit may include: an abbreviated word generation rule storage unit that holds a generation rule for generating an abbreviated word using moras; a candidate generation unit that generates candidate abbreviated words, each being made up of one or more moras, by extracting one or more moras from the mora strings of the respective constituent words and concatenating the extracted moras; and an abbreviated word determination unit that determines an abbreviated word for final generation, by applying the generation rule held by the abbreviated word generation rule storage unit to the generated candidate abbreviated words.

With the above structure, it becomes possible to generate a speech recognition dictionary creation device that (i) allows for the generation of a highly-likely abbreviated phrase for a new recognition object by previously constructing a rule for generating an abbreviated phrase by extracting partial mora strings from mora strings of the constituent words and concatenating the extracted partial mora strings, and (ii) realizes a speech recognition device capable of correctly recognizing an utterance of not only the recognition object but also an abbreviated phrase of such recognition object by registering the generated abbreviated phrase into the recognition dictionary as a recognition vocabulary.

Furthermore, the abbreviated word generation rule storage unit may hold a plurality of generation rules, the abbreviated word determination unit may calculate a likelihood under each of the generation rules stored in the abbreviated word generation rule storage unit and determine an utterance probability by comprehensively taking into account the calculated likelihoods, the utterance probability being determined for each of the generated candidate abbreviated words, and the vocabulary storage unit may hold the abbreviated word and the utterance probability that are determined by the abbreviated word determination unit. Here, the abbreviated word determination unit may determine the utterance probability by summing up values that are obtained by multiplying the likelihoods for the respective generation rules by corresponding weighting factors, and the abbreviated word determination unit may determine that a candidate abbreviated word is the abbreviated word for final generation in the case where the utterance probability of the candidate abbreviated word exceeds a predetermined threshold.

With the above structure, an utterance probability is calculated for each of one or more abbreviated words generated for the recognition object and then stored into the above speech recognition dictionary in association with their respective abbreviated words. Accordingly, it becomes possible to create a speech recognition dictionary that realizes a speech recognition device capable of performing recognition with high accuracy in speech comparison, since a weight that is appropriate for the calculated utterance probability is assigned to each abbreviated word without having to narrow down only to one of two or more abbreviated words generated for one recognition object and a low probability is assigned to an abbreviated word that is predicted to be less likely to be used as an abbreviated word.

Moreover, the abbreviated word generation rule storage unit may hold a first rule concerning dependency relationship between words, and the abbreviated word determination unit may determine, based on the first rule, the abbreviated word for final generation from among the candidates. For example, the first rule may include a condition that an abbreviated word should be generated using a modifier and a modified word as a pair, or may include a rule indicating a relationship between the likelihood and a distance between a modifier and a modified word that make up an abbreviated word.

The above structure makes it possible to take into account a relationship between words that constitute the recognition object at the time of generating an abbreviated word of the recognition object and thus to generate an abbreviated word that is based on a relationship between the constituent words. Accordingly, it becomes possible to create a speech recognition dictionary that realizes a speech recognition device capable of performing recognition with high accuracy since it becomes possible to exclude a word that is less likely to be included in an abbreviated word from among the constituent words included in the recognition object and to mainly use, in contrast, a word that is highly likely to be included in an abbreviated word, as a result of which it becomes possible to generate a more appropriate abbreviated word and to prevent an abbreviated word that is less likely to be used from being registered into the recognition dictionary.

Furthermore, the abbreviated word generation rule storage unit may hold a second rule that is related to at least one of a length of a partial mora string and a position of the partial mora string, the length being a length of the partial mora string that is extracted from a mora string of the constituent word when an abbreviated word is generated, and the position being a position of the partial mora string in the constituent word, and the abbreviated word determination unit may determine, based on the second rule, the abbreviated word for final generation from among the candidates. For example, the second rule may include a rule indicating a relationship between the likelihood and a number of moras indicating the length of the partial mora string, or may include a rule indicating a relationship between the likelihood and a number of moras indicating a distance from a top of the constituent word to the partial mora string, the distance indicating the position of the partial mora string in the constituent word.

The above structure makes it possible to take into account the number of extracted partial mora strings, the position at which each mora appear, and the total number of moras included in the generated abbreviated word at the time of generating an abbreviated word by concatenating partial moras of the words that constitute the recognition object. Accordingly, it becomes possible to regularize a general tendency related to the extraction of phonemes at the time of generating an abbreviated word by dividing into phonemes a long word or a phrase made up of plural words, using mora that is a basic unit of the phonemic rhythm of the Japanese language or the like. Thus, it becomes possible to create a speech recognition dictionary that realizes a speech recognition device capable of performing recognition with high accuracy since it is possible to generate a more appropriate abbreviated word when generating an abbreviated word of a recognition object and to prevent an abbreviated word that is less likely to be used from being registered into a recognition dictionary.

Moreover, the abbreviated word generation rule storage unit may hold a third rule related to concatenated partial mora strings that make up an abbreviated word, and the abbreviated word determination unit may determine, based on the third rule, the abbreviated word for final generation from among the candidates. For example, the third rule may include a rule indicating a relationship between the likelihood and a combination of a last mora and a top mora, the last mora being included in a former of the concatenated two partial mora strings and the top mora being included in a latter of the concatenated two partial mora strings.

The above structure makes it possible to regularize, in the form of probability of mora concatenation, a general tendency that a phoneme sequence that is natural as the Japanese language or the like is preferred at the time of generating an abbreviated word from a long word or a phrase made up of plural words. Thus, it becomes possible to create a speech recognition dictionary that realizes a speech recognition device capable of performing recognition with high accuracy since it is possible to generate a more appropriate abbreviated word when generating an abbreviated word from a recognition object and to prevent an abbreviated word that is less likely to be used from being registered into the recognition dictionary.

Furthermore, the speech recognition dictionary creation device may further include: an extraction condition storage unit that holds a condition for extracting the recognition object from character string information that includes the recognition object; a character string information obtainment unit that obtains the character string information that includes the recognition object; and a recognition object extraction unit that extracts the recognition object from the character string information obtained by the character string information obtainment unit according to the condition held by the extraction condition storage unit, and sends the extracted recognition object to the word division unit.

The above structure makes it possible to extract a recognition object in an appropriate manner in accordance with a condition for extracting a recognition object from character string information and to automatically generate an abbreviated word corresponding to such recognition object so as to store it into the speech recognition dictionary. Moreover, an utterance probability is calculated for each abbreviated word generated, based on a likelihood for a rule that has been applied at the time of abbreviated word generation and such utterance probability is also stored into the speech recognition dictionary. Accordingly, it becomes possible to create a speech recognition dictionary that realizes a speech recognition device capable of performing recognition with high accuracy in speech comparison, since an utterance probability is assigned to each of one ore more abbreviated words that are automatically generated from the character string information.

Furthermore, in order to achieve the above object, the speech recognition device according to the present invention is a speech recognition device that recognizes an input speech by comparing the input speech with a model corresponding to a vocabulary registered in a speech recognition dictionary, the device recognizing the speech using the speech recognition dictionary created by the above-described speech recognition dictionary creation device.

The above structure makes it possible to include, as a comparison target in recognition processing, not only a vocabulary in a previously generated speech recognition dictionary but also a vocabulary in the speech recognition dictionary that stores a recognition object extracted from character string information and an abbreviated word generated from such recognition object by the speech recognition dictionary creation device of the present invention. Accordingly, it becomes possible to realize a speech recognition device that is capable of correctly recognizing not only a fixed vocabulary such as a command, but also a vocabulary extracted from the character string information, such as a search keyword, as well as its abbreviated word, regardless of which one of them is uttered.

Here, the speech recognition device according to the present invention is a speech recognition device that recognizes an input speech by comparing the input speech with a model corresponding to a vocabulary registered in a speech recognition dictionary, the device including the above-described speech recognition dictionary creation device and recognizing the speech using the speech recognition dictionary created by the speech recognition dictionary creation device.

With the above structure, the extraction of a recognition object and the generation of its abbreviated word are automatically carried out by inputting the character string information to the integrated speech recognition dictionary creation device, and they are stored into the speech recognition dictionary. Since it is possible for the speech recognition device to compare a speech with these vocabularies stored in the speech recognition dictionary, it becomes possible for the speech recognition device having a vocabulary to which addition or change should be variably made to automatically extract such vocabulary and its abbreviated word from the character string information and register them into the speech recognition dictionary.

Here, the abbreviated word and the utterance probability of the abbreviated word may be registered into the speech recognition dictionary together with the recognition object, and the recognition unit may recognize the speech by taking into account the utterance probability registered in the speech recognition dictionary. The speech recognition device may generate a candidate for a recognition result of the speech and a likelihood of the candidate, add a likelihood corresponding to the utterance probability to the generated likelihood, and output the candidate as a final recognition result based on the resulting addition value.

With the above structure, an utterance probability of each abbreviated word is calculated and stored into the speech recognition dictionary in the process of extracting a recognition object from the character string information and generating its abbreviated word. Accordingly, it becomes possible for the speech recognition device to perform a comparison by taking into account the utterance probability of each abbreviated word at the time of speech comparison and to perform a control so that a lower probability is assigned to a less-likely abbreviated word. As a result, it becomes possible to minimize the reduction in the probability of the accuracy of speech recognition due to an excessive generation of unnatural abbreviated words.

Moreover, the speech recognition device may further include: an abbreviated word use history storage unit that holds, as use history information, an abbreviated word recognized for the speech and a recognition object corresponding to the abbreviated word; and an abbreviated word generation control unit that controls generation of an abbreviated word by the abbreviated word generation unit based on the use history information held by the abbreviated word use history storage unit. For example, the abbreviated word generation unit of the speech recognition dictionary creation device may include: an abbreviated word generation rule storage unit that holds a generation rule for generating an abbreviated word using moras; a candidate generation unit that generates candidate abbreviated words, each being made up of one or more moras, by extracting one or more moras from the mora strings of the respective constituent words and concatenating the extracted moras; and an abbreviated word determination unit that determines an abbreviated word for final generation, by applying the generation rule held by the abbreviated word generation rule storage unit to the generated candidate abbreviated word, and the abbreviated word generation control unit may control the generation of the abbreviated word by making one of change, deletion, and addition to the generation rule held by the abbreviated word generation rule storage unit.

Similarly, the speech recognition device may further include: an abbreviated word use history storage unit that holds, as use history information, an abbreviated word recognized for the speech and a recognition object corresponding to the abbreviated word; and a dictionary revision unit that revises the abbreviated word stored in the speech recognition dictionary based on the use history information held by the abbreviated word use history storage unit. For example, the abbreviated word and the utterance probability of the abbreviated word may be registered into the speech recognition dictionary together with the recognition object, and the dictionary update unit may revise the abbreviated word by changing the utterance probability of the abbreviated word.

The above structure makes it possible to control the abbreviated word generation rule by taking into account the user's tendency regarding the use of abbreviated words, based on the history information about the user's use of abbreviated words in the past. This is a result of focusing on the fact that there is a certain tendency for the user's use of abbreviated words and that the number of abbreviated words used by the user for the same word is two at most. In other words, it becomes possible to generate, when newly generating abbreviated words, only those abbreviated words that are judged to be highly likely to be used from the past use of abbreviated words. Furthermore, as for abbreviated words that are already stored in the recognition dictionary, if such abbreviated words are ones generated from the same word and it has become obvious that only one of them is used and the others are not used, it becomes possible to delete the unused abbreviated words from the dictionary. Such function prevents an excessive number of abbreviated words from being registered into the recognition dictionary as well as minimizing the degradation in the performance of speech recognition. Furthermore, also in the case where a common abbreviated word is included in abbreviated words that are generated for different recognition objects, it is possible to predict which recognition object the user is intending to mean from information indicating the user's specific use of abbreviated words in the past.

Note that not only is it possible to embody the present invention as a speech recognition dictionary creation device and a speech recognition device as described above, but also as a speech recognition dictionary creation method and a speech recognition method that include, as their respective steps, the characteristic components included in these devices as well as programs that cause a computer to execute these steps. It should be also understood that such programs can be distributed on a recording medium such as a CD-ROM and over a communication medium such as the Internet.

### BRIEF DESCRIPTION OF DRAWINGS

FIG. 1 is a functional block diagram showing a structure of a speech recognition dictionary creation device according to a first embodiment of the present invention.

FIG. 2 is a flowchart showing dictionary creation processing performed by the above speech recognition dictionary creation device.

FIG. 3 is a flowchart showing a detailed procedure of the abbreviated word generation process (S23) shown in FIG. 2.

FIG. 4 is a diagram showing a processing table (table that holds intermediate data and the like that are temporarily generated) held by an abbreviated word generation unit of the above speech recognition dictionary creation device.

FIG. 5 is a diagram showing an example of abbreviated word generation rules stored in an abbreviated word generation rule storage unit of the above speech recognition dictionary creation device.

FIG. 6 is a diagram showing an example of the speech recognition dictionary stored in a vocabulary storage unit of the above speech recognition dictionary creation device.

FIG. 7 is a functional block diagram showing a structure of a speech recognition device according to a second embodiment of the present invention.

FIG. 8 is a flowchart showing a learning function of the above speech recognition device.

FIGS. 9A and 9B are diagrams showing an application example of the above speech recognition device.

FIG. 10A is a diagram showing example abbreviated words generated by the speech recognition dictionary creation device 10 from a recognition object in the Chinese language, and FIG. 10B is a diagram showing example abbreviated words generated by the speech recognition dictionary creation device 10 from a recognition object in the English language.

### BEST MODE FOR CARRYING OUT THE INVENTION

The following describes the embodiments of the present invention with reference to the drawings.

### First Embodiment

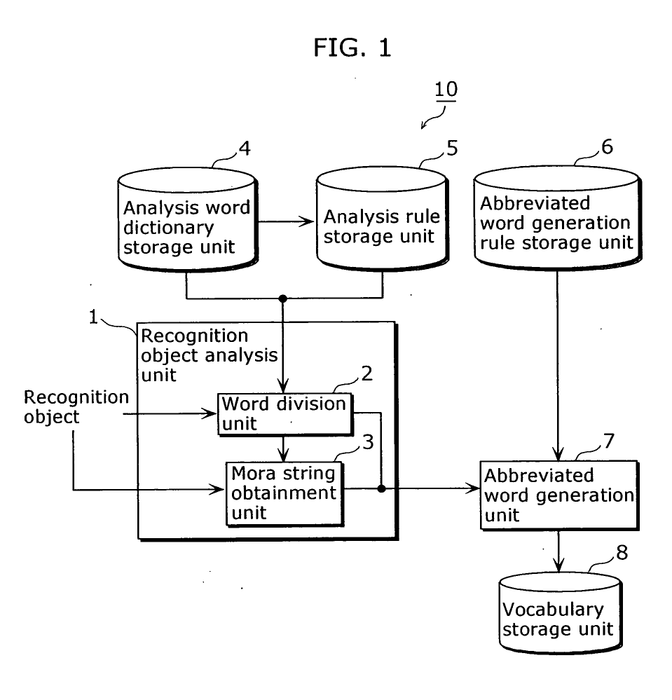

FIG. 1 is a functional block diagram showing a structure of a speech recognition dictionary creation device 10 according to the first embodiment. The present speech recognition dictionary creation device 10, which is a device that generates an abbreviated word from a recognition object and registers it as a dictionary, is comprised of: a recognition object analysis unit 1 and an abbreviated word generation unit 7 that are implemented as a program, a logical circuit, or the like; and an analysis word dictionary storage unit 4, an analysis rule storage unit 5, an abbreviated word generation rule storage unit 6, and a vocabulary storage unit 8 that are implemented as storage devices such as a hard disk and a non-volatile memory.

The analysis word dictionary storage unit 4 stores, in advance, a dictionary related to word units (morphemes) and the definitions of their phoneme sequences (phonemic information) that are used for dividing a recognition object into its constituent words. The analysis rule storage unit 5 stores, in advance, rules (rules concerning syntactic analysis) for dividing a recognition object into word units stored in the analysis word dictionary storage unit 4.

The abbreviated word generation rule storage unit 6 stores, in advance, a plurality of rules concerning the generation of an abbreviated word of a previously constructed word, i.e., a plurality of rules that take into account the ease of pronunciation. For example, such rules include: a rule for determining, from among the constituent words of the recognition object, a word from which a partial mora string should be extracted based on the constituent words themselves and on their respective dependency relationship; a rule for extracting appropriate partial moras based on positions from which partial moras are extracted from the constituent words, the number of extracted moras, and a total number of moras resulted from combining the extracted moras; a rule for concatenating partial moras based on whether it is natural or not to concatenate such extracted moras; and so forth.

Note that “mora”, which is a phoneme considered as one sound (one beat), corresponds approximately to each of hiragana characters when a Japanese word is written in hiragana. Furthermore, mora corresponds to one sound in haiku when counted in a 5-7-5 pattern. Note, however, that as for palatalized consonant (sound that is followed by small “ya” “yu” and “yo”), double consonant (small “tu”/choked sound), and syllabic nasal /N/, whether they are treated as an independent syllable nor not depends on whether they are pronounced as one sound (one beat) or not. For example, “Tokyo” consists of four moras “to”, “u”, “kyo”, and “u”, “Sapporo” consists of four moras “sa” “p”, “po”, and “ro”, and “Gunma” consists of three moras “gu”, “n”, and “ma”.

The recognition object analysis unit 1, which is a processing unit that performs morphemic analysis, syntax analysis, and mora analysis, or the like on the recognition object inputted to the speech recognition dictionary creation device 10, is comprised of a word division unit 2 and a mora string obtainment unit 3. The word division unit 2 divides the input recognition object into words that constitute such recognition object (constituent words) according to information about words stored in the analysis word dictionary storage unit 4 and the syntax analysis rule stored in the analysis rule storage unit 5, and generates a dependency relationship between the resulting constituent words (information indicating a relationship between a modifier and a modified word). The mora string obtainment unit 3 generates a mora string for each of the constituent words generated by the word division unit 2, based on the phonemic information about the words stored in the analysis word dictionary storage unit 4. Results of analysis performed by the recognition object analysis unit 1, i.e., information generated by the word division unit 2 (information about the constituent words of the recognition object and a dependency relationship among the respective words) and information generated by the mora string obtainment unit 3 (mora strings indicating phoneme sequences of the respective constituent words) are sent to the abbreviated word generation unit 7.

The abbreviated word generation unit 7 generates zero or more abbreviated words of the recognition object from the information about the recognition object sent from the recognition object analysis unit 1, using the abbreviated word generation rules stored in the abbreviated word generation rule storage unit 6. More specifically, the abbreviated word generation unit 7 generates candidate abbreviated words by combining mora strings of the respective words sent from the recognition object analysis unit 1 based on their dependency relationship, and calculates likelihoods of the generated candidate abbreviated words for each of the rules stored in the abbreviated word generation rule storage unit 6. Then, after assigning a constant weight to the likelihoods and adding up the resulting likelihoods, the abbreviated word generation unit 7 calculates an utterance probability of each of the candidates, and stores, into the vocabulary storage unit 8, a candidate with an utterance probability above a certain level as the abbreviated word for final generation, in association with the utterance probability and the original recognition object. In other words, an abbreviated word that is judged by the abbreviated word generation unit 7 as having an utterance probability above a certain level, is stored into the vocabulary storage unit 8 as a speech recognition dictionary together with its utterance probability and information indicating that such word has the same meaning as that of the input recognition object.

The vocabulary storage unit 8 holds rewritable speech recognition dictionaries and performs registration processing. The vocabulary storage unit 8 associates the abbreviated word and its utterance probability generated by the abbreviated word generation unit 7 in association with the recognition object inputted to the speech recognition dictionary creation device 10, and registers such recognition object, abbreviated word, and utterance probability as a speech recognition dictionary.

Next, providing concrete examples, a description is given of operations performed by the speech recognition dictionary creation device 10 with the above structure.

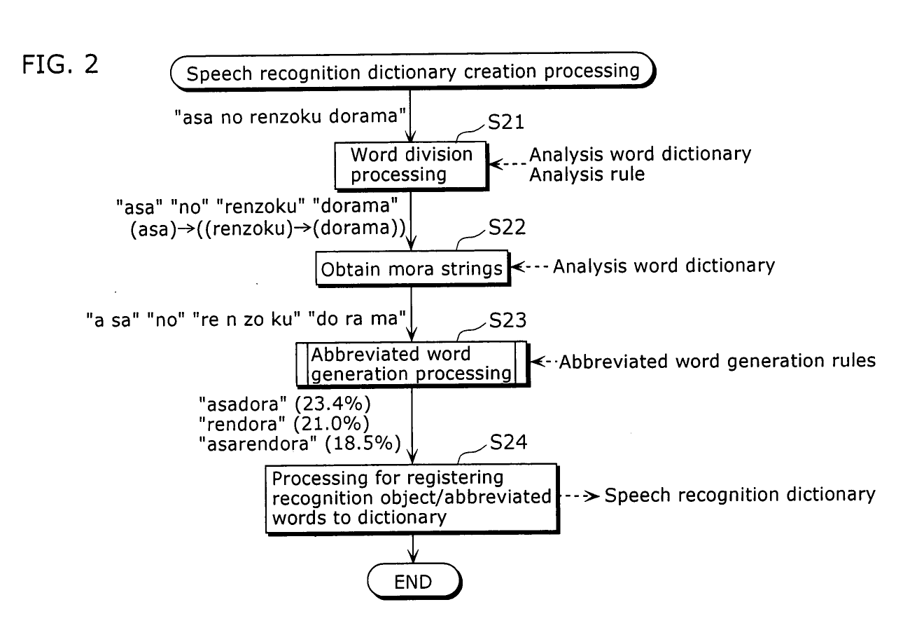

FIG. 2 is a flowchart showing dictionary creation operations performed by the respective units included in the speech recognition dictionary creation device 10. In the drawing, illustrated on the left of the arrows are specific data to be generated such as intermediate data, final data, and the like in the case where “asa no renzoku dorama (Morning drama series)” is inputted as a recognition object, whereas illustrated on the right are names of data to be referred to or to be stored.

First, in Step S21, the recognition object is read into the word division unit 2 of the recognition object analysis unit 1. The word division unit 2 divides the recognition object into its constituent words according to information about the words stored in the analysis word dictionary storage unit 4 and the word division rule stored in the analysis rule storage unit 5, and determines a dependency relationship among the respective constituent words. In other words, the word division unit 2 performs morphemic analysis and syntax analysis. Accordingly, the recognition object “asa no renzoku dorama” is divided, for example, into constituent words “asa”, “no”, “renzoku”, and “dorama”, and (asa)->((renzoku)->(dorama)) is generated as a dependency relationship. In this representation of the dependency relationship, a word from which an arrow is extending indicates a modifier, whereas a word pointed by an arrow indicates a modified word.

In Step S22, the mora string obtainment unit 3 assigns, as a phoneme sequence, a mora string to each of the constituent words obtained in the word division processing step S21. In the present step, the phonemic information of the words stored in the analysis word dictionary storage unit 4 is used to obtain the phoneme sequences of the respective constituent words. As a result, “a sa”, “no”, “re n zo ku”, and “do ra ma” are provided as mora strings of the constituent words obtained in the word division unit 2, “asa”, “no”, “renzoku”, and “dorama”. The mora strings that are generated in the above manner are sent to the abbreviated word generation unit 7 together with information about the constituent words and dependency relationship obtained in Step S21.

In Step 23, the abbreviated word generation unit 7 generates abbreviated words based on the constituent words, dependency relationship, and mora strings sent from the recognition object analysis unit 1. When this is done, one or more of the rules stored in the abbreviated word generation rule storage unit 6 are applied. Such rules include: a rule for determining, from among the constituent words of the recognition object, a word from which a partial mora string should be extracted based on the constituent words themselves and their dependency relationship; a rule for extracting appropriate partial moras based on positions in the respective constituent words from which such partial moras are extracted, the number of extracted moras, and a total number of moras resulted from combining the extracted moras; a rule for concatenating partial moras based on whether it is natural or not to concatenate such extracted moras; and so forth. The abbreviated word generation unit 7 calculates a likelihood based on each of the rules to be applied when generating abbreviated words, the likelihood indicating the degree to which each abbreviated word satisfies the applied rule. Then, by summing up the likelihoods for the respective rules, the abbreviated word generation unit 7 calculates an utterance probability of each of the generated abbreviated words. As a result, “asadora”, “rendora”, and “asarendora” are generated as abbreviated words, to which a higher utterance probability is assigned in this order.

In Step 24, the vocabulary storage unit 8 stores, into the speech recognition dictionary, pairs of the abbreviated words and their utterance probabilities generated by the abbreviated word generation unit 7, in association with the recognition object. In this manner, the speech recognition dictionary that contains the abbreviated words of the recognition object and their utterance probabilities is generated.

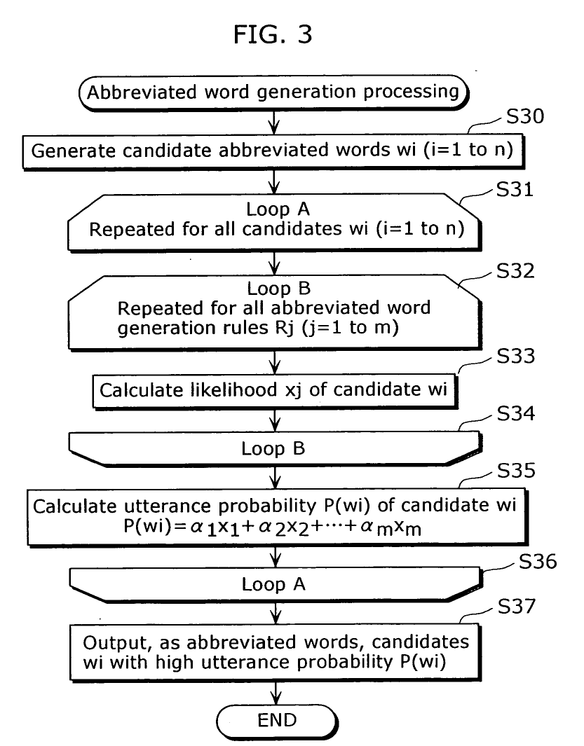

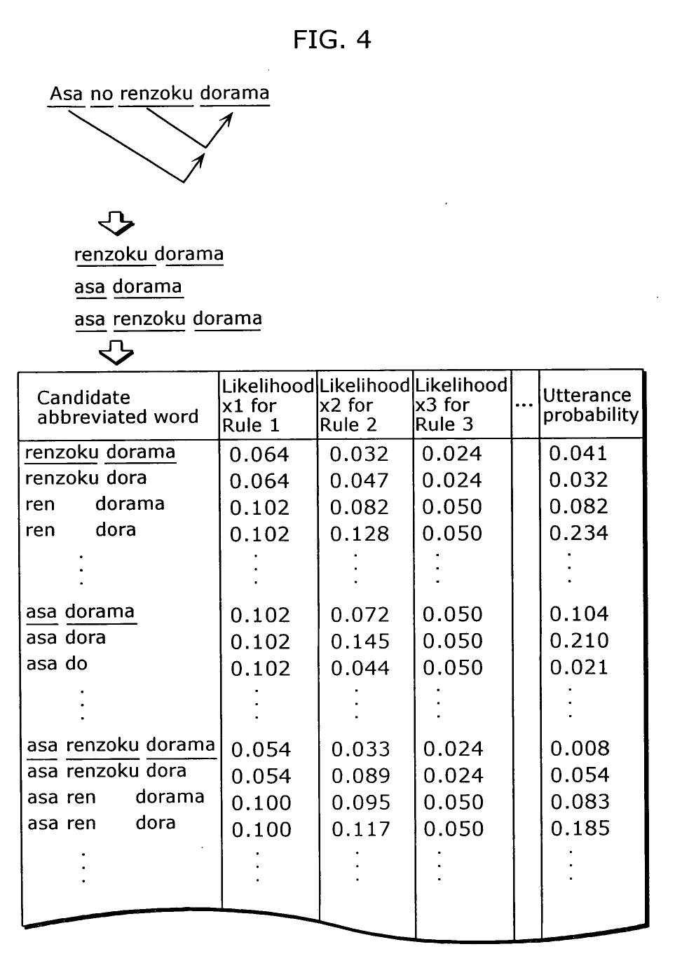

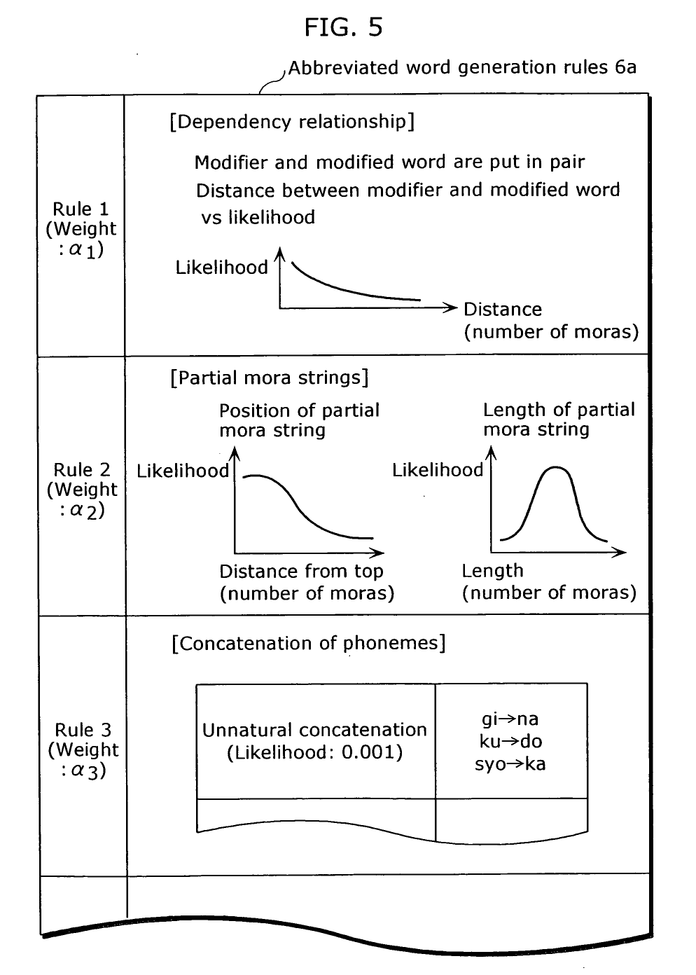

Next, referring to FIGS. 3 to 5, a description is given of a detailed procedure of the abbreviated word generation processing (S23) shown in FIG. 2. FIG. 3 is a flowchart showing such detailed procedure, FIG. 4 shows a processing table (table that holds intermediate data and the like that are temporarily generated) held by the abbreviated word generation unit 7, and FIG. 5 is a diagram showing an example of abbreviated word generation rules 6a stored in the abbreviated word generation rule storage unit 6.

First, the abbreviated word generation unit 7 generates candidate abbreviated words based on the constituent words, dependency relationship, and mora strings sent from the recognition object analysis unit 1 (S30 in FIG. 3). More specifically, the abbreviated word generation unit 7 generates candidate abbreviated words by combining each of all the modifiers and modified words indicated in the dependency relationship among the constituent words sent from the recognition object analysis unit 1. When this is done, as illustrated as “Candidate abbreviated word” in the processing table of FIG. 4, not only the mora strings of the constituent words, but also partial mora strings that are results of deleting a part of the respective mora strings, are used as modifiers and modified words. For example, in the case of a modifier “renzoku” and a modified word “dorama”, not only “renzokudorama”, but also all possible mora strings that are obtained by deleting one or mora moras are generated as candidate abbreviated words.

Next, the abbreviated word generation unit 7 repeats the following processes (S30 to S36 in FIG. 3) for each of the generated candidate abbreviated words (from S31 in FIG. 3): calculates a likelihood based on each of the abbreviated word generation rules stored in the abbreviated word generation rule storage unit 6 (S32 to S34 in FIG. 3); and calculates each utterance probability by summing up the likelihoods based on a certain weight (S35 in FIG. 3).

For example, suppose that a rule concerning dependency relationship is defined as one of the abbreviated word generation rules as shown as Rule 1 in FIG. 5, which defines that a modifier and a modified word should be concatenated in this order and which defines a function or the like indicating that a likelihood becomes higher as the distance (the number of stages in the dependency relationship shown at the top FIG. 4) between a modifier and a modified word is shorter. In this case, the abbreviated word generation unit 7 calculates likelihoods in accordance with such Rule 1 for each of the candidate abbreviated words. In the case of “rendora”, for example, after confirming that it is an abbreviated word whose modifier and modified word are concatenated in the defined order (otherwise, its likelihood is 0), the distance between the modifier (ren) and the modified word “dora” (here, one stage since “ren(zoku)” modifies “dora(ma)” is determined, and a likelihood corresponding to such distance (here, 0.102) is determined according to the above function.

Meanwhile, in the case of “asadora”, the distance between the modifier “asa” and the modified word “dora” is two stages since “asa” modifies “renzoku dorama”, whereas in the case of “asarendora”, the distance between the modifier and the modified word is 1.5 stages, which is the mean value of the two distances, since “asarendora” has dependency relationships for both “rendora” and “asadora”.

Furthermore, suppose that a rule concerning partial mora string is defined as another example of the abbreviated word generation rules as shown as Rule 2 in FIG. 5, which defines rules or the like concerning the position and length of a partial mora string. More specifically, as the rule concerning the position of a partial mora string, a rule is defined specifying that a likelihood becomes higher as the position of a mora string (partial mora string) determined to be used as a modifier or a modified word is located closer to the top of its original constituent word. In other words, a function or the like is defined that indicates a relationship between the distance from the top (the number of moras between the top of the original constituent word and the top of the partial mora string) and a likelihood. In addition, as the rule concerning the length of a partial mora string, a rule is defined specifying that a likelihood becomes higher as the number of moras making up a partial mora string is closer to two. In other words, a function that indicates a relationship between the length of a partial mora string (the number of moras) and a likelihood is defined. The abbreviated word generation unit 7 calculates a likelihood of each of the candidate abbreviated words in accordance with such Rule 2. In the case of “asadora”, for example, the position and length of each of the partial mora strings “asa” and “dora” are determined, and a likelihood of each of them is determined in accordance with the above function. Then, the mean value of the resulting likelihoods is determined (here, 0.128) as a likelihood for Rule 2.

Moreover, suppose that a rule concerning the concatenation of morphemes is defined as another example of the abbreviated word generation rules as shown as Rule 3 in FIG. 5, which defines a rule or the like concerning a concatenated part of partial mora strings. Here, as the rule concerning a concatenated part of partial mora strings, a data table is defined specifying that a likelihood becomes low in the case where two partial mora strings are concatenated, and the last mora in the fore partial mora string and the top mora in the rear partial mora string is unnaturally concatenated from the standpoint of phonemic combination (phonemes that are difficult to pronounce). The abbreviated word generation unit 7 calculates a likelihood in accordance with Rule 3 of each of the candidate abbreviated words. More specifically, the abbreviated word generation unit 7 judges whether or not each concatenated part of partial mora strings applies to any of unnatural concatenations registered in Rule 3. The abbreviated word generation unit 7 assigns a likelihood accordingly, when any of them applies, whereas it assigns the default likelihood (here, 0.050) otherwise. For example, in the case of “asarendora”, it is judged whether “sare” that is the concatenated part of partial mora strings “asa” and “ren” applies to any of unnatural concatenations registered in Rule 3. Here, since any of them applies, the default likelihood (here, 0.050) is assigned.

As described above, after a likelihood of each of the candidate abbreviated words is calculated under the application of each of the abbreviated word generation rules, the abbreviated word generation unit 7 calculates an utterance probability of each candidate by summing up each likelihood x that is multiplied by weight (weight α shown in FIG. 5 that is defined on a rule-by-rule basis) according to the formula shown in Step 35 in FIG. 3 for determining an utterance probability P(w) (S35 in FIG. 3).

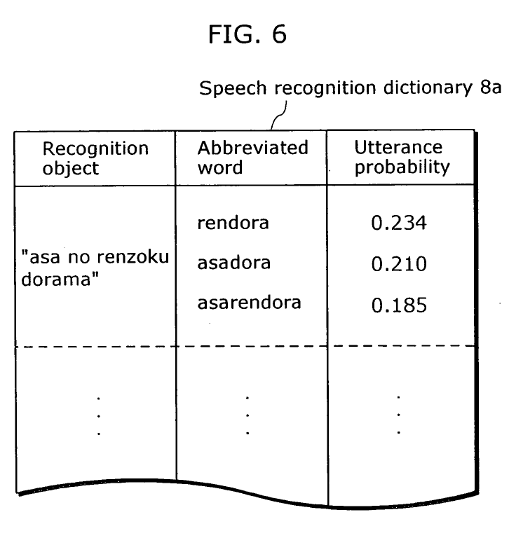

Finally, the abbreviated word generation unit 7 identifies, from all the candidates, candidate(s) with an utterance probability above a predetermined threshold, and outputs them to the vocabulary storage unit 8 as the abbreviated words for final generation, together with their utterance probabilities (S37 in FIG. 3). Accordingly, as shown in FIG. 6, the vocabulary storage unit 8 creates a speech recognition dictionary 8a that contains the abbreviated words of the recognition object and their utterance probabilities.

The speech recognition dictionary 8a that has been created in the above manner contains not only the recognition object, but also its abbreviated words and their utterance probabilities. Thus, the use of the speech recognition dictionary created by the present speech recognition dictionary creation device 10 makes it possible to provide a speech recognition device that is capable of recognizing a speech with high recognition rate regardless of whether a word is uttered in a formal manner or in an abbreviated manner, by detecting that they are utterances of the same intention. For example, in the case of “asa no renzoku dorama”, regardless of whether the user says “asanorenzokudorama” or “asadora”, it is recognized that such utterance means “asa no renzoku dorama” and a speech recognition dictionary with the same functionality is created for the speech recognition device.

### Second Embodiment

The second embodiment relates to an example of a speech recognition device that is integrated with the speech recognition dictionary creation device 10 of the first embodiment, and that uses the speech recognition dictionary 8a created by such speech recognition dictionary creation device 10. The speech recognition device related to the present embodiment has a dictionary update function of automatically extracting a recognition object from character string information and storing it into the speech recognition dictionary and a function of preventing less likely abbreviated word from being registered into the recognition dictionary by controlling the generation of abbreviated words using information that is based on the user's history of using abbreviated words. Note that the character string information is information that includes a word to be recognized (recognition object) by the speech recognition device. For example, in the case of a speech recognition device that automatically switches the channel to a television program based on the name of a television program uttered by a viewer watching digital television broadcasting, the name of the television program serves as a recognition object and electronic program data broadcast from a broadcast station serves as character string information.

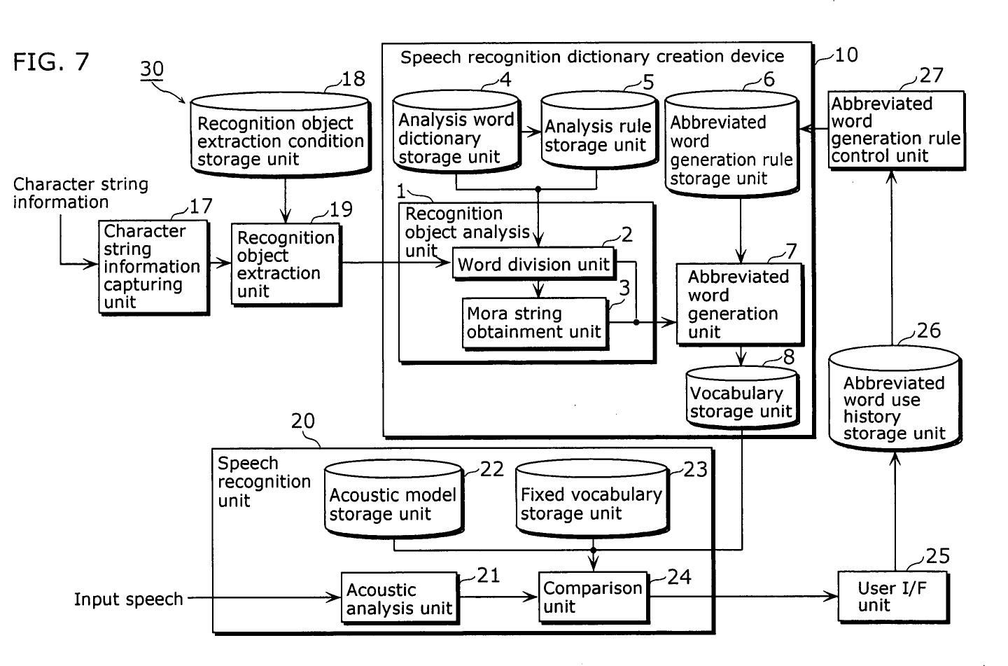

FIG. 7 is a functional block diagram showing a structure of a speech recognition device 30 according to the second embodiment. Such speech recognition device 30 is equipped with a character string information capturing unit 17, a recognition object extraction condition storage unit 18, a recognition object extraction unit 19, a speech recognition unit 20, a user I/F unit 25, an abbreviated word use history storage unit 26, and an abbreviated word generation rule control unit 27, in addition to the speech recognition dictionary creation device 10 of the first embodiment. Note that the speech recognition dictionary creation device 10 is the same as the one presented in the first embodiment, and therefore a description thereof is not repeated here.

The character string information capturing unit 17, the recognition object extraction condition storage unit 18, and the recognition object extraction unit 19 are intended for extracting a recognition object from the character string information that includes such recognition object. According to the present structure, the character string information capturing unit 17 captures the character string information that includes the recognition object, and the recognition object extraction unit 19 in the subsequent stage extracts the recognition object from such character string information. In preparation for extracting the recognition object from the character string information, morphemic analysis is performed on the character string information, and then the recognition object is extracted according to a recognition object extraction condition stored in the recognition object extraction condition storage unit 18. The extracted recognition object is sent to the speech recognition dictionary creation device 10, which is followed by the generation of its abbreviated words and their registration into the recognition dictionary.

Accordingly, it becomes possible for the speech recognition device 30 according to the present embodiment to automatically extract a search keyword, such as a television program name, from character string information such as electronic program data, and then to create a speech recognition dictionary that makes it possible to correctly perform speech recognition regardless of whether the keyword or an abbreviated word generated therefrom is uttered. Note that the recognition object extraction condition stored in the recognition object extraction condition storage unit 18 is, for example, information for identifying electronic program data included in digital broadcast data to be inputted to a digital broadcast receiver and information for identifying the name of a television program included in electronic program data.

The speech recognition unit 20 is a processing unit that performs speech recognition of an input speech inputted via a microphone or the like based on the speech recognition dictionary created by the speech recognition dictionary creation device 10. Such speech recognition unit 20 is comprised of an acoustic analysis unit 21, an acoustic model storage unit 22, a fixed vocabulary storage unit 23, and a comparison unit 24. The acoustic analysis unit 21 performs frequency analysis or the like on the speech inputted via the microphone or the like so as to convert it into a sequence of feature parameters (e.g., mel-cepsturm coefficient). The comparison unit 24 synthesizes models for recognizing the respective vocabularies and compares the resultant with the input speech, using a model stored in the acoustic model storage unit 22 (e.g., hidden Markov model and Gaussian mixture distributions) based on the vocabulary (fixed vocabulary) stored in the fixed vocabulary storage unit 23 or the vocabulary (normal words and abbreviated words) stored in the vocabulary storage unit 8. As a result, words that are given higher likelihoods are sent to the user I/F unit 25 as candidate recognition results.

With the above structure, by storing, into the fixed vocabulary storage unit 23, vocabulary that can be determined at the time of system construction, such as device control command (e.g., an utterance “kirikae (switch to another)” to be uttered when switching a television program to another) and by storing, into the vocabulary storage unit 8, vocabulary, such as a television program to be switched to, that needs to be variably changed in response to changes in the name of a television program, it becomes possible to simultaneously recognize both of such vocabularies.

Furthermore, the vocabulary storage unit 8 stores not only abbreviated words but also their utterance probabilities. The utterance probabilities are used by the comparison unit 24 to perform speech comparison. By making it less easy to recognize an abbreviated word with low utterance probability, it is possible to prevent the decrease in the performance of the speech recognition device due to an excessive generation of abbreviated words. For example, the comparison unit 24 adds the likelihood corresponding to an utterance probability (e.g. the logarithmic value of the utterance probability) stored in the vocabulary storage unit 8 to a likelihood indicating the correlation between the input speech and a vocabulary stored in the vocabulary storage unit 8, and determines the resulting addition value as a final likelihood of the recognition result. When such final likelihood exceeds a predetermined threshold, the comparison unit 24 sends such vocabulary to the user I/F unit 25 as a candidate recognition result. Note that when there are a plurality of candidate recognition results whose likelihood exceeds the predetermined threshold, only those included in predetermined ranks in descending order of likelihood are sent to the user I/F unit 25.

Meanwhile, there is a possibility that the speech recognition dictionary creation device 10 as above generates abbreviated words with identical phoneme sequences for a plurality of different recognition objects. This problem is caused by the ambiguity of the abbreviated word generation rules. It is assumed in ordinary cases that the user uses one abbreviated word to mean one corresponding recognition object. Thus, a speech recognition device to be required is capable of presenting an appropriate operation based on an uttered abbreviated word by overcoming the ambiguity of the abbreviated word generation rules and has a learning function that improves the recognition rate over a long period of usage. The user I/F unit 25, the abbreviated word use history storage unit 26, and the abbreviated word generation rule control unit 27 are the components intended for such learning function.

In other words, in the case of a failure to narrow down the candidate recognition results to one candidate as a result of the speech comparison performed by the comparison unit 24, the user I/F unit 25 presents such plurality of candidates to the user so as to obtain a selection instruction from the user. For example, the user I/F unit 25 displays, on the television screen, a plurality of candidates for recognition result (plural names of television programs to be switched to) that have been obtained in response to a user's utterance. Accordingly it becomes possible for the user to have a desired operation (program switching by speech) by selecting the correct candidate from among them by use of a remote control or the like.

The abbreviated words that are sent to the user I/F unit 25 or the abbreviated word that has been selected by the user from among those sent by the user I/F unit 25 in the above manner are sent to the abbreviated word use history storage unit 26 as history information and stored therein. The history information stored in the abbreviated word use history storage unit 26 is evaluated in the abbreviated word generation rule control unit 27 and is used to change rules and parameters intended for generating abbreviated words stored in the abbreviated word generation rule storage unit 6 as well as to change parameters intended for calculating utterance probabilities of the abbreviated words. At the same time, in the case where a one-to-one correspondence is established between an original word and its abbreviated word based on a user's usage of the abbreviated word, such information is stored into the abbreviated word generation rule storage unit as well. Such information regarding addition/change/deletion of rules stored in the abbreviated word generation rule storage unit 6 is sent also to the vocabulary storage unit 8, where the already registered abbreviated words are reviewed and the dictionary is updated accordingly by deleting or changing abbreviated words.

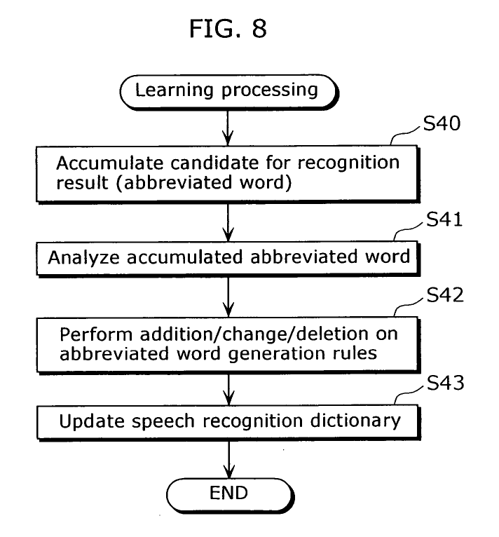

FIG. 8 is a flowchart showing a learning function of the speech recognition device 30 with the above structure.

In the case where recognition candidate results sent from the comparison unit 24 include an abbreviated word stored in the vocabulary storage unit 8, the user I/F unit 25 causes the abbreviated word use history storage unit 26 to accumulate such abbreviated word by sending it to the abbreviated word history storage unit 26 (S40). When this is done, the abbreviated word selected by the user is sent to the abbreviated word use history storage unit 26, said abbreviated word being added with information indicating such fact.

The abbreviated word generation rule control unit 27 generates regularity by statistically analyzing the abbreviated words stored in the abbreviated word use history storage unit 26 at predetermined time intervals or every time a predetermined amount of information is stored in the abbreviated word use history storage unit 26 (S41). For example, the abbreviated word generation rule control unit 27 generates a frequency distribution related to the length of abbreviated words (the number of moras), a frequency distribution related to a sequence of moras constituting abbreviated words, or the like. When it has been confirmed, based on information about user's selection or the like, that the television program name “asa no renzoku dorama” is abbreviated as “rendora”, for example, the abbreviated word generation rule control unit 27 also generates information indicating a one-to-one correspondence between the recognition object and the abbreviated word. After generating regularity as described above, the abbreviated word generation rule control unit 27 deletes the contents stored in the abbreviated word use history storage unit 26 to get ready for future accumulation.

Then, according to the generated regularity, the abbreviated word generation rule control unit 27 performs one of addition, change, and deletion of the abbreviated word generation rules stored in the abbreviated word generation rule storage unit 6 (S42). For example, based on the frequency distribution concerning the length of abbreviated words, the abbreviated word generation rule control unit 27 makes an amendment to the rule concerning the length of partial mora strings (e.g., a parameter for obtaining the mean value, out of function parameters indicating the distribution) included in Rule 2 shown in FIG. 5. Furthermore, in the case where information indicating a one-to-one correspondence between a recognition object and an abbreviated word is generated, the abbreviated word generation rule control unit 27 registers such correspondence as a new abbreviated word generation rule.

As described above, the abbreviated word generation unit 7 reviews the speech recognition dictionary stored in the vocabulary storage unit 8, by repeatedly generating an abbreviated word of the recognition object according to the abbreviated word generation rules on which addition/change/deletion has been performed (S43). For example, when having re-calculated the utterance probability of the abbreviated word “asadora” in accordance with such new abbreviated word generation rules, the abbreviated word generation unit 7 updates the utterance probability, whereas when the user selects “rendora” as an abbreviated word of the recognition object “asa no renzoku dorama”, the abbreviated word generation unit 7 raises the utterance probability of the abbreviated word “rendora”.

As described above, since the present speech recognition device 30 is capable of not only performing speech recognition for abbreviated words as well, but also updating the abbreviated word generation rules in accordance with a recognition result so as to revise the speech recognition dictionary accordingly, it becomes possible to achieve a learning function that improves the recognition rate over a period of usage.

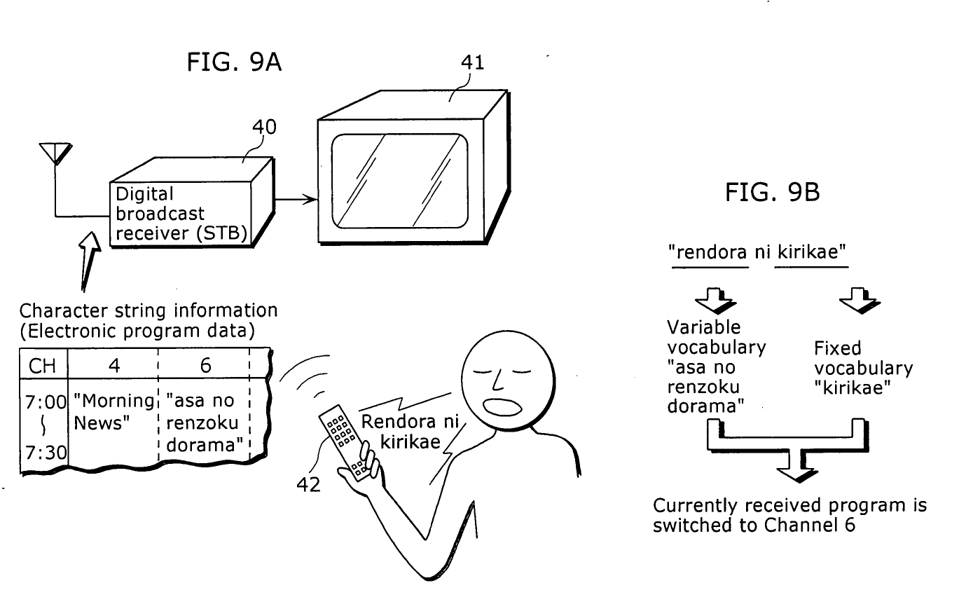

FIG. 9A is a diagram showing an application example of the above-described speech recognition device 30.

Illustrated in the drawing is a system for automatically switching a television program to another in response to a speech. Such system is composed of: a set-top box (STB: a digital broadcast receiver) 40 that contains the speech recognition device 30; a TV receiver 41; and a remote control 42 that is capable of functioning as a wireless microphone. An utterance of the user is sent to the STB 40 via the microphone of the remote control 42 as speech data, and is speech-recognized by the speech recognition device 30 contained in the STB 40. Accordingly, the television program is switched to another in accordance with the result of such recognition.

For example, suppose the case where a user's utterance is “rendora ni kirikae (switch the channel to the rendora)”. In this case, such speech is sent to the speech recognition device 30 contained in the STB 40 via the remote control 42. As shown in the processing procedure of FIG. 9B, the speech recognition unit 20 of the speech recognition device 30 detects that the input speech “rendora ni kirikae” contains a variable vocabulary “rendora” (i.e., the recognition object “asa no renzoku doram”) and a fixed vocabulary “kirikae”, with reference to the vocabulary storage unit 8 and fixed vocabulary storage unit 23. Based on this result, the STB 40 exercises control for selecting the television program “asa no renzoku dorama” (here, Channel 6) after confirming that the electronic program data that has been previously received and stored as broadcast data includes such television program currently on the air.

As described above, according to the speech recognition device of the present embodiment, not only is it possible to simultaneously recognize a fixed vocabulary such as a command for device control and a variable vocabulary such as a television program name used for searching for a program, but also to perform desired processing by associating the control of a device or the like with a fixed vocabulary, a variable vocabulary, and further its abbreviated word. What is more, it becomes also possible to efficiently create a speech recognition dictionary with high recognition rate by providing a learning function that takes into account the user's past use history, thereby overcoming the ambiguity related to the process of generating abbreviated words.

The speech recognition dictionary creation device and speech recognition device according to the present invention have been described as above, but the present invention is not limited to the aforementioned embodiments.

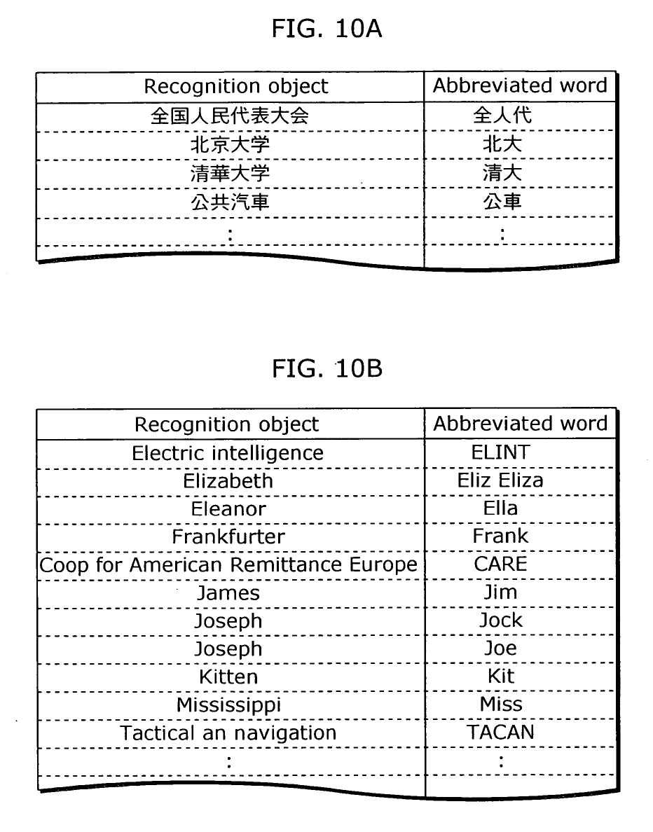

More specifically, the first and second embodiments present an example of the speech recognition dictionary creation device 10 and speech recognition device 30 intended for the Japanese language, but it should be understood that the present invention is applicable not only to the Japanese language, but also to other languages such as the Chinese language and the English language. FIG. 10A is a diagram showing example abbreviated words generated by the speech recognition dictionary creation device 10 from a Chinese recognition object, whereas FIG. 10B is a diagram showing example abbreviated words generated by the speech recognition dictionary creation device 10 from an English recognition object. These abbreviated words can be generated under abbreviated word generation rules depicted in FIG. 5 as the abbreviated word generation rules 6a such as “the top one syllable of the recognition object is used as an abbreviated word” and “concatenation of the top one syllables of the respective words constituting the recognition object is used as an abbreviated word”.

Also, the speech recognition dictionary creation device 10 according to the first embodiment has been described to generate abbreviated words with high utterance probability, but non-abbreviated normal words may also be generated. For example, the abbreviated word generation unit 7 may not only register, into the speech recognition dictionary of the vocabulary storage unit 8, abbreviated words, but also may register a mora string corresponding to a non-abbreviated recognition object as a fixed mora string, together with a predetermined utterance probability. Alternatively, it is also possible to simultaneously recognize a normal word spelled in full and an abbreviated word by causing the speech recognition device to include, as a recognition object, not only abbreviated words registered in its speech recognition dictionary, but also recognition object serving as indexes of the speech recognition dictionary.

Furthermore, the abbreviated word generation rule control unit 27 according to the first embodiment has been described to make a change to the abbreviated word generation rules stored in the abbreviated word generation rule storage unit 6, but it may directly make a change to the contents of the vocabulary storage unit 8. More specifically, addition, change, or deletion may be performed on abbreviated words registered in the speech recognition dictionary 8a stored in the vocabulary storage unit 8a and increase/decrease in the utterance probabilities of the registered abbreviated words may be performed. Accordingly, the speech recognition dictionary is directly revised based on the use history information stored in the abbreviated word use history storage unit 26.

Furthermore, the abbreviated word generation rules stored in the abbreviated word generation rule storage unit 6 as well as the definitions of words used in the rules are not limited to those used in the present embodiment. For example, in the present embodiment, although the distance between a modifier and a modified word indicates a stage in a dependency relationship diagram, the present invention is not limited to such definition, and thus “the distance between a modifier and a modified word” may be defined as a value that indicates whether a connection of a modifier and a modified word is appropriate or not from a semantic viewpoint. For example, in the case of “(burning red (evening sun))” and “(bright blue (evening sun))”, since the former is natural from a semantic viewpoint, a standard may be adopted by which it is indicated that the distance is closer in the former case.

Furthermore, the second embodiment presents, as an application example of the speech recognition device 30, automatic program switching performed in a digital broadcast receiving system, but such automatic program switching is not limited to a one-way communication system such as a broadcast system, and thus the present invention is also applicable to a two-way communication system such as the Internet and telephone network. For example, by integrating the speech recognition device of the present invention into a mobile telephone, it becomes possible to realize a content distribution system in which a user's specification of a desired content is speech-recognized, and such content is downloaded from a website on the Internet. For example, when the user says “Kuma P wo download (download kuma P)”, a variable vocabulary “kuma P (an abbreviated word of “Kuma no P-san (Bear named pi))” and a fixed vocabulary “download” are recognized, and a mobile phone ringing melody “Kuma no P-san” is downloaded to the mobile phone from a website on the Internet.

Similarly, the speech recognition device 30 of the present invention is not limited to a communication system such as a broadcast system and a content distribution system, and thus is also applicable to a stand-alone device. For example, by integrating the speech recognition device 30 of the present invention into a car navigation device, it is possible to realize a convenient, highly-secured car navigation device that is capable of recognizing a place name or the like of a destination uttered by a driver and automatically displaying a map to such destination. For example, when a driver says, “kadokado wo hyouji (Display kadokado)”, a variable vocabulary “kadokado (an abbreviated word of “Oaza Kadoma, Kadoma-Shi, Osaka”)” and a fixed vocabulary “hyoji (display)” are recognized, and a map of the neighborhood of “Oaza Kadoma, Kadoma-Shi, Osaka” is automatically displayed on the screen of the car navigation.

As described above, the present invention makes it possible to create a speech recognition dictionary intended for speech recognition device that operates in the same manner in both cases where a recognition object is uttered in a formal manner and where it is uttered in an abbreviated manner. Furthermore, since abbreviated word generation rules focusing on moras being the rhythm of producing a speech in the Japanese language are applied and weights are assigned to abbreviated words in consideration of their respective utterance probabilities, it becomes possible to prevent abbreviated words from being unnecessarily generated and registered into the recognition dictionary and to prevent generated abbreviated words from inversely affecting the performance of the speech recognition device through a combined use of weighting.

Moreover, the speech recognition device integrated with the above-described speech recognition dictionary creation device is capable of constructing a speech recognition dictionary in an efficient manner since it is possible to resolve the problem caused by a many-to-may relationship between original word and abbreviated word that is attributable to the ambiguity of the abbreviated word generation rules, by the speech recognition dictionary creation unit utilizing the user's history about the use of abbreviated words.

Furthermore, since the speech recognition device of the present invention establishes a feedback system for reflecting a recognition result to the process of creating a speech recognition dictionary, it is possible to achieve a learning effect that the recognition rate becomes higher over a period of using the device.

As described above, since the present invention is capable of recognizing a speech that includes an abbreviated word with high recognition rate, it becomes possible through a speech that includes an abbreviated word to switch a television program to another, operate a mobile phone, and provide an instruction or the like to a car navigation device. Thus, the present invention is capable of offering a highly significant practical value.

### INDUSTRIAL APPLICABILITY

It is possible to use the present invention as a speech recognition dictionary creation device for creating a dictionary used for a speech recognition device intended for an unspecified speaker and as a speech recognition device and the like for performing speech recognition using such dictionary. The present invention, in particular, is applicable to a speech recognition device or the like for recognizing a vocabulary that includes an abbreviated word, an example of which is a digital broadcast receiver and a car navigation device.

1. A speech recognition dictionary creation device that creates a speech recognition dictionary, said device comprising:
an abbreviated word generation unit operable to generate an abbreviated word of a recognition object that is made up of one or more constituent words based on a rule that takes into account ease of pronunciation; and
a vocabulary storage unit operable to hold, as the speech recognition dictionary, the generated abbreviated word together with the recognition object.

2. The speech recognition dictionary creation device according to claim 1, further comprising:
a word division unit operable to divide the recognition object into the constituent words; and
a mora string generation unit operable to generate mora strings of the respective constituent words based on readings of the respective divided constituent words,
wherein said abbreviated word generation unit is operable to generate the abbreviated word made up of one or more moras by extracting one or more moras from the mora strings of the respective constituent words and concatenating the extracted moras based on the mora strings of the respective constituent words generated by said mora string generation unit.

3. The speech recognition dictionary creation device according to claim 2,
wherein said abbreviated word generation unit includes:
an abbreviated word generation rule storage unit operable to hold a generation rule for generating an abbreviated word using moras;
a candidate generation unit operable to generate candidate abbreviated words, each being made up of one or more moras, by extracting one or more moras from the mora strings of the respective constituent words and concatenating the extracted moras; and
an abbreviated word determination unit operable to determine an abbreviated word for final generation, by applying the generation rule held by said abbreviated word generation rule storage unit to the generated candidate abbreviated words.

4. The speech recognition dictionary creation device according to claim 3,
wherein said abbreviated word generation rule storage unit is operable to hold a plurality of generation rules,
said abbreviated word determination unit is operable to calculate a likelihood under each of the generation rules stored in said abbreviated word generation rule storage unit and to determine an utterance probability by comprehensively taking into account the calculated likelihoods, the utterance probability being determined for each of the generated candidate abbreviated words, and
said vocabulary storage unit is operable to hold the abbreviated word and the utterance probability that are determined by said abbreviated word determination unit.

5. The speech recognition dictionary creation device according to claim 4,
wherein said abbreviated word determination unit is operable to determine the utterance probability by summing up values that are obtained by multiplying the likelihoods for the respective generation rules by corresponding weighting factors.

6. The speech recognition dictionary creation device according to claim 5,
wherein said abbreviated word determination unit is operable to determine that a candidate abbreviated word is the abbreviated word for final generation in the case where the utterance probability of the candidate abbreviated word exceeds a predetermined threshold.

7. The speech recognition dictionary creation device according to claim 4,
wherein said abbreviated word generation rule storage unit is operable to hold a first rule concerning dependency relationship between words, and
said abbreviated word determination unit is operable to determine, based on the first rule, the abbreviated word for final generation from among the candidates.

8. The speech recognition dictionary creation device according to claim 7,
wherein the first rule includes a condition that an abbreviated word should be generated using a modifier and a modified word as a pair.

9. The speech recognition dictionary creation device according to claim 7,
wherein the first rule includes a rule indicating a relationship between the likelihood and a distance between a modifier and a modified word that make up an abbreviated word.

10. The speech recognition dictionary creation device according to claim 4,
wherein said abbreviated word generation rule storage unit is operable to hold a second rule that is related to at least one of a length of a partial mora string and a position of the partial mora string, the length being a length of the partial mora string that is extracted from a mora string of the constituent word when an abbreviated word is generated, and the position being a position of the partial mora string in the constituent word, and
said abbreviated word determination unit is operable to determine, based on the second rule, the abbreviated word for final generation from among the candidates.

11. The speech recognition dictionary creation device according to claim 10,
wherein the second rule includes a rule indicating a relationship between the likelihood and a number of moras indicating the length of the partial mora string.

12. The speech recognition dictionary creation device according to claim 10,
wherein the second rule includes a rule indicating a relationship between the likelihood and a number of moras indicating a distance from a top of the constituent word to the partial mora string, the distance indicating the position of the partial mora string in the constituent word.

13. The speech recognition dictionary creation device according to claim 4,
wherein said abbreviated word generation rule storage unit is operable to hold a third rule related to concatenated partial mora strings that make up an abbreviated word, and
said abbreviated word determination unit is operable to determine, based on the third rule, the abbreviated word for final generation from among the candidates.

14. The speech recognition dictionary creation device according to claim 13,
wherein the third rule includes a rule indicating a relationship between the likelihood and a combination of a last mora and a top mora, the last mora being included in a former of the concatenated two partial mora strings and the top mora being included in a latter of the concatenated two partial mora strings.

15. The speech recognition dictionary creation device according to claim 2, further comprising:
an extraction condition storage unit operable to hold a condition for extracting the recognition object from character string information that includes the recognition object;
a character string information obtainment unit operable to obtain the character string information that includes the recognition object; and
a recognition object extraction unit operable to extract the recognition object from the character string information obtained by said character string information obtainment unit according to the condition held by said extraction condition storage unit, and to send the extracted recognition object to said word division unit.

16. A speech recognition device that recognizes an input speech by comparing the input speech with a model corresponding to a vocabulary registered in a speech recognition dictionary, said device comprising
a recognition unit operable to recognize the speech using the speech recognition dictionary created by the speech recognition dictionary creation device according to claim 1.

17. The speech recognition device according to claim 16,
wherein the abbreviated word and the utterance probability of the abbreviated word are registered into the speech recognition dictionary together with the recognition object, and
said recognition unit is operable to recognize the speech by taking into account the utterance probability registered in the speech recognition dictionary.

18. The speech recognition device according to claim 17,
wherein said recognition unit is operable (i) to generate a candidate for a recognition result of the speech and a likelihood of the candidate, (ii) to add a likelihood corresponding to the utterance probability to the generated likelihood, and (iii) to output the candidate as a final recognition result based on the resulting addition value.

19. The speech recognition device according to claim 16, further comprising:
an abbreviated word use history storage unit operable to hold, as use history information, an abbreviated word recognized for the speech and a recognition object corresponding to the abbreviated word; and
an abbreviated word generation control unit operable to control generation of an abbreviated word by the abbreviated word generation unit based on the use history information held by said abbreviated word use history storage unit.

20. The speech recognition device according to claim 19,
wherein the abbreviated word generation unit of the speech recognition dictionary creation device includes:
an abbreviated word generation rule storage unit operable to hold a generation rule for generating an abbreviated word using moras;
a candidate generation unit operable to generate candidate abbreviated words, each being made up of one or more moras, by extracting one or more moras from the mora strings of the respective constituent words and concatenating the extracted moras; and
an abbreviated word determination unit operable to determine an abbreviated word for final generation, by applying the generation rule held by said abbreviated word generation rule storage unit to the generated candidate abbreviated word, and
said abbreviated word generation control unit is operable to control the generation of the abbreviated word by making one of change, deletion, and addition to the generation rule held by the abbreviated word generation rule storage unit.

21. The speech recognition device according to claim 16, further comprising:
an abbreviated word use history storage unit operable to hold, as use history information, an abbreviated word recognized for the speech and a recognition object corresponding to the abbreviated word; and
a dictionary revision unit operable to revise the abbreviated word stored in the speech recognition dictionary based on the use history information held by said abbreviated word use history storage unit.

22. The speech recognition device according to claim 21,
wherein the abbreviated word and the utterance probability of the abbreviated word are registered into the speech recognition dictionary together with the recognition object, and
said dictionary update unit is operable to revise the abbreviated word by changing the utterance probability of the abbreviated word.

23. A speech recognition device that recognizes an input speech by comparing the input speech with a model corresponding to a vocabulary registered in a speech recognition dictionary, said device comprising:
the speech recognition dictionary creation device according to claim 1; and
a recognition unit operable to recognize the speech using the speech recognition dictionary created by said speech recognition dictionary creation device.

24. A speech recognition dictionary creation method for creating a speech recognition dictionary, said method comprising the steps of:
generating an abbreviated word of a recognition object that is made up of one or more constituent words based on a rule that takes into account ease of pronunciation; and
registering, into the speech recognition dictionary, the generated abbreviated word together with the recognition object.

25. The speech recognition dictionary creation method according to claim 24, further comprising:
dividing the recognition object into the constituent words; and
generating mora strings of the respective constituent words based on readings of the respective divided constituent words,
wherein in said generating of the abbreviated word, the abbreviated word made up of one or more moras is generated by extracting one or more moras from the mora strings of the respective constituent words and concatenating the extracted moras based on the mora strings of the respective constituent words generated by said mora string generation unit.

26. A speech recognition method for recognizing an input speech by comparing the input speech with a model corresponding to a vocabulary registered in a speech recognition dictionary, said method comprising the step of
recognizing the speech using the speech recognition dictionary created by the speech recognition dictionary creation method according to claim 24.

27. A speech recognition method for recognizing an input speech by comparing the input speech with a model corresponding to a vocabulary registered in a speech recognition dictionary, said method comprising:
the steps included in the speech recognition dictionary creation method according to claim 24; and
a step of recognizing the speech using the speech recognition dictionary created by the speech recognition dictionary creation method.

28. A program for a speech recognition dictionary creation device that creates a speech recognition dictionary, said program causing a computer to execute the steps included in the speech recognition dictionary creation method according to claim 24.

29. A program for a speech recognition device that recognizes an input speech by comparing the input speech with a model corresponding to a vocabulary registered in a speech recognition dictionary, said program causing a computer to execute the step included in the speech recognition method according to claim 26.
